(19) United States
(12) Patent Application Publication
(10) Pub. No.: US 2009/0144789 A1
(43) Pub. Date: Jun. 4, 2009

(54) SYSTEMS, METHODS, AND COMPUTER PRODUCTS FOR STORAGE OF MUSIC VIA IPTV

(75) Inventors: Ke Yu, Alpharetta, GA (US); Michael Branam, Lawrenceville, GA (US); Akbar Pirani, Marietta, GA (US); E-Lee Chang, Mableton, GA (US); Madhur Khandelwal, Atlanta, GA (US); Timothy Weaver, Alpharetta, GA (US)

Correspondence Address: AT&T Legal Department - CC;Attn: Patent Docketing, Room 2A-207, One AT&T Way, Bedminster, NJ, 07921, US

(73) Assignee: AT&T Delaware Intellectual Property, Inc., Wilmington, DE (US)

(21) Appl. No.: 12/168,839

(22) Filed: Jul. 7, 2008

Related U.S. Application Data
(63) Continuation of application No. 11/948,848, filed on Nov. 30, 2007, now abandoned.

(51) Int. Cl. H04N 7/173

(52) U.S. Cl. 725/110

(57) ABSTRACT

Systems, methods, and computer products for storage of music via Internet Protocol Television (IPTV) are disclosed herein. Exemplary embodiments include a network-based method for audio storage. The method includes receiving a request to store audio data, retrieving the audio data through an Internet Protocol television (IPTV) network, and storing the audio data in an audio repository in communication with the IPTV network.

### CROSS-REFERENCE TO RELATED APPLICATIONS

This application is a continuation of U.S. patent application Ser. No. 11/948,848 filed Nov. 30, 2007, the disclosure of which is incorporated by reference herein in its entirety. The co-pending application is assigned to the same assignee as this application, AT&T Delaware Intellectual Property, Inc. of Wilmington, Del.

### BACKGROUND

Exemplary embodiments generally relate to telecommunications, and more particularly, to systems, methods, and computer products for storage of music/audio via Internet Protocol Television.

Internet Protocol Television (IPTV) is a digital television delivery service wherein a digital television signal is delivered to users (i.e., subscribers) via a computer network infrastructure using the Internet Protocol. Typically, IPTV services are bundled with additional Internet services such as Internet web access and voice over Internet protocol (VOIP). Subscribers may receive IPTV services via a set-top box that is connected to a television or display device for the reception of an audio/video signal. Used in conjunction with an IP-based platform, the set-top box allows for the subscribers to access IPTV based services and additional services that are integrated within the IPTV platform.

IPTV service platforms allow for an increase in the interactive services that may be provided to the subscribers. As such, the subscribers may have access to a wide variety of content that is available via the IPTV service or the Internet. For example, a subscriber may utilize interactive services via a set-top box to view IPTV content or access personal electronic messaging accounts via an Internet web browser. The IPTV infrastructure may also allow instant delivery of a variety of audio/video content to the subscriber, including music and/or audio.

In conventional cable and satellite based television delivery systems, the subscriber is limited to storing audio/video content either by recording pre-determined programming content such as network television and/or cable stations such as HBO® or by purchasing digital video disks (DVD) or other media with desired content. Further, if the subscriber wishes to view previously stored content remotely (i.e., away from recording devices at home), the subscriber must either take the recording device to the remote location for viewing, or travel with storage media usable at the location. However, the subscriber may wish to view stored content at a plurality of locations without traveling with storage media. Furthermore, the subscriber may wish to store music without using a personal recording device such as a digital video recorder (DVR) at home, and without having to store individual music files. In conventional cable and satellite based television delivery systems, there are no solutions for providing storage of music independent of location.

It may therefore be desirable to provide a means for providing storage of music/audio via IPTV to subscribers.

### BRIEF SUMMARY

Exemplary embodiments include a network-based method for providing music/audio storage. The method includes receiving a request to store audio data, retrieving the audio data through an Internet Protocol television (IPTV) network, and storing the audio data in an audio repository in communication with the IPTV network.

Additional exemplary embodiments include a system for providing network-based audio storage. The system includes a computer processing device, and an audio storage application executing on the computer processing device. The audio storage application includes receiving a request to store audio data, retrieving the audio data through an Internet Protocol television (IPTV) network, and storing the audio data in an audio repository in communication with the IPTV network.

Further exemplary embodiments include a computer program product. The computer program product includes instructions for causing a computer to implement a method. According to exemplary embodiments, the method includes receiving a request to store audio data, retrieving the audio data through an Internet Protocol television (IPTV) network, and storing the audio data in an audio repository in communication with the IPTV network.

Other systems, methods, and/or computer program products according to exemplary embodiments will be or become apparent to one with skill in the art upon review of the following drawings and detailed description. It is intended that all such additional systems, methods, and/or computer program products be included within this description, be within the scope of the exemplary embodiments, and be protected by the claims set forth at the end of this specification.

### BRIEF DESCRIPTION OF DRAWINGS

Referring now to the drawings wherein like elements are numbered alike in the several FIGURES:

FIG. 1 illustrates a block diagram of an music/audio storage system 100 in accordance with exemplary embodiments;

FIG. 2 illustrates a flow chart for a method of music/audio storage 200 in accordance with exemplary embodiments;

FIG. 3 illustrates a flow chart for a method of music/audio storage 300 in accordance with exemplary embodiments;

FIG. 4 illustrates a screen shot of an exemplary music/audio storage system interface 300 in accordance with exemplary embodiments; and

FIG. 5 illustrates a screen shot of an exemplary music/audio storage system interface 400 in accordance with exemplary embodiments.

The detailed description explains the exemplary embodiments, together with advantages and features, by way of example with reference to the drawings.

### DETAILED DESCRIPTION OF EXEMPLARY EMBODIMENTS

Detailed illustrative embodiments are discussed hereinafter. However, specific functional details disclosed herein are merely representative for purposes of describing exemplary embodiments. Exemplary embodiments may, however, be embodied in many alternate forms and should not be construed as limited to only the embodiments set forth herein.

Accordingly, while exemplary embodiments are capable of various modifications and alternative forms, particular embodiments are shown by way of examples in the drawings and will be described in detail herein. It should be understood, however, that there is no intent to limit exemplary embodiments to the particular forms disclosed, but to the contrary, exemplary embodiments are to cover all modifications, equivalents, and alternatives falling within the scope of exemplary embodiments. Like numbers refer to like elements throughout the description of the figures.

It will be understood that, although the terms first, second, etc. may be used herein to describe various steps or calculations, these steps or calculations should not be limited by these terms. These terms are only used to distinguish one step or calculation from another. For example, a first calculation could be termed a second calculation, and similarly, a second step could be termed a first step, without departing from the scope of this disclosure. As used herein, the term “and/or” includes any and all combinations of one or more of the associated listed items.

As used herein, the singular forms “a”, “an” and “the” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

In exemplary embodiments, systems, methods, and computer program products provide a subscriber and users of subscribers' devices storage of music via IPTV, the terms “subscribers” and “users” being used interchangeably in the description that follows. The music may be accessed through an IPTV network, and played back on a communications device. In exemplary embodiments, the subscriber is provided a “folder” that includes, for example, availability for storage of music/audio data, including playlists, content listings, music preferences, etc. The subscriber may select music and/or audio available through IPTV services for storage in the folder as part of a playlist or listing. Playlists or listings within the folder are selectable by the subscriber for playback of associated music/audio content on a communications device. When the subscriber accesses the folder and selects a playlist (or portion thereof), the associated audio/music is streamed to the subscriber's location, for example, to a set-top box. The subscriber can access any playlist in the folder at any time. Further, the subscriber may have access to a plurality of folders associated with a plurality of different music/audio content categories. In exemplary embodiments, the folders (or the playlists in the folders) contain pointers, which provide access to the music/audio content for streaming to the subscriber's set-top box (or alternatively, communications device). In further exemplary embodiments, the music/audio can be stored temporarily on the subscriber's digital video recorder, such as in a cache. In addition, the subscriber may travel to another location that has access to the IPTV network, and if the user provides the correct authentication credentials, the user is able to access the folder(s) of stored music from that location.

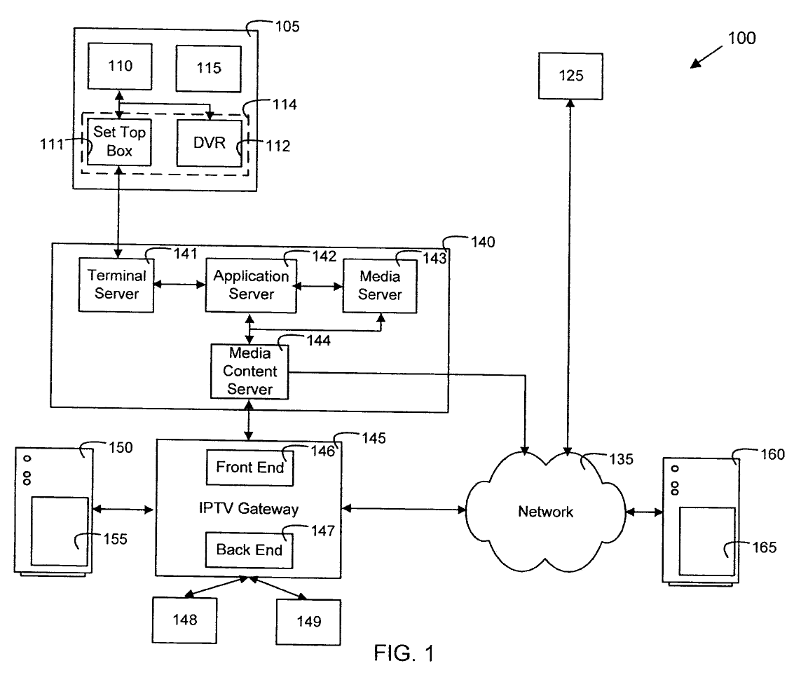

Turning to FIG. 1, a block diagram of an exemplary music/audio storage system 100 is illustrated. For ease of illustration, the system 100 of FIG. 1 depicts a simplified network infrastructure. In addition, for ease of illustration, the system 100 is described implementing an Internet Protocol Television (IPTV) system for reception of programming, scheduling, and IPTV-based services. It is understood that the systems and methods described herein may implement television and program-viewing systems other than IPTV. For example, the system 100 may implement cable, satellite, antenna, etc.

Furthermore, it is understood that a variety of network components/nodes may be utilized in implementing the embodiments described herein. For example, in exemplary embodiments, the system 100 includes a means for accessing network services for multiple disparate devices using a single sign-on procedure. The means for accessing network services may include one or more IPTV infrastructure(s) 140, IPTV gateways 145, and/or other suitable components/nodes. Therefore, the system 100 manages accounts, each of which may be established for a community of devices and/or device subscribers, such as those devices and subscribers at a subscriber location 105, which may include a communications device 110 (e.g., a display device or television) operatively connected to a computing device 111, such as a set-top box. Where the communications device 110 is a television, the set-top box 111 includes a processor that provides bi-directional communications between the IPTV infrastructure 140 and the communications device 110, and decodes the streaming media received as content programming and onscreen programming information, from a content services provider system 160, discussed further below.

Other services may be provided to the subscriber location 105, such as, but not limited to, phone services, network services, and other services such as providing storage of music that may be played back at the communications device 110. The accounts may thus include phone, network access, and IPTV services, and may be used to provide access to music storage as described further herein. Furthermore, in exemplary embodiments, one of the devices (e.g., the communications device 110) may be provisioned for the network services described herein by associating a device identifier of the communications device 110 with a respective account. The account, in turn, identifies each of the communications devices belonging to the community and provides other information as described herein. Furthermore, it is appreciated that other devices such as a subscriber computer 125 may be further included in the community of devices established for the subscriber location 105. It is appreciated that the subscriber computer 125 may be local to the subscriber location 105 or may represent any other computer that may be used to access the services described herein. It is further appreciated that other remote devices may be implemented to access the services described herein such as but not limited to a cellular telephone (e.g., a 3G cell phone), a personal computer, a laptop computer, a portable computing device (e.g., personal digital assistant), a digital music player (e.g., MP3 player), etc.

In exemplary embodiments, one of the devices, such as the communications device 110 (or the communications device 110 and set-top box 111 combination) may be used to establish account services, such as music storage. An account record may be generated for the subscriber at the subscriber location 105, which identifies the subscriber and the account for the services (e.g., basic account services as described above). Account information and records may be stored in a storage device accessible by the IPTV gateway 145, discussed below. In exemplary embodiments, the IPTV gateway 145 implements one or more applications for establishing and utilizing access to the account. Access to the account may thus be created for a community of communications devices (e.g., the communications device 110) to enable the communications devices to store music and access stored music. A music repository 150, which is coupled to the IPTV gateway 145, includes storage media 155 for storage of music as described further herein.

As discussed above, the system 100 of FIG. 1 includes the subscriber location 105, such as the subscriber's household. The subscriber location 105 may include the communications device 110 (e.g., an IPTV-enabled television) in communication with the set-top box 111. The subscriber location 105 may further include a personal digital recorder such as a digital video recorder (DVR) 112, which is in communication with the communication device 110 and the set-top box 111. It is understood that the set-top box 111 and the DVR 112 may be two separate devices or be a single integrated device 114. In exemplary embodiments, the DVR 112 may be hard-disk based, but may alternatively have other suitable storage media such as a cache or solid-state memory, or have a hard-disk and other storage medium combination. It is appreciated that the DVR 112 may have other suitable memory devices for receiving and storing programming and scheduling data. Therefore, a “memory” or “recording medium” may be any means that contains, stores, communicates, propagates, or transports the program and/or data for use by or in conjunction with an instruction execution system, apparatus or device. Memory and recording medium may be, but are not limited to, an electronic, magnetic, optical, electromagnetic, infrared, or semiconductor system, apparatus or device. Memory and recording mediums also include, but are not limited to, for example, the following: a portable computer diskette, a random access memory (RAM), a read-only memory (ROM), an erasable programmable read-only memory (EPROM or flash memory), and a portable compact disk read-only memory or another suitable medium upon which a program and/or data may be stored.

The subscriber location 105 may further include a remote control 115 for control and navigation of the communications device 110, which may be used to select and listen to music/audio on the communications device 110. As discussed above, the subscriber location 105 may further include one or more remote devices in its community of devices. For example, the remote devices in the community of devices may include the subscriber computer 125. In exemplary embodiments, the subscriber computer 125 may be part of the subscriber location 105 or a computer that is accessed remotely in order to playback stored music/audio content and control, manage, and/or schedule content from the content services provider system 160 transmitted to the subscriber location 105 for rendering on the communications device 110. It is therefore appreciated that access to music/audio storage may be managed from locations remote to the subscriber location 105. It is understood by those skilled in the art that the subscriber computer 125 may include input and output devices, such as but not limited to a mouse, a keyboard, etc. As discussed further below, the aforementioned devices may all interact with the IPTV infrastructure 140 and the IPTV gateway 145. It is appreciated that any of the aforementioned devices may access music/audio storage according to exemplary embodiments. Furthermore, in exemplary embodiments, the communications devices described herein may have a network address associated with the communications devices such as an addressable uniform resource locator (URL), an Internet address, etc.

In exemplary embodiments, the system 100 may manage and access music/audio storage through the subscriber's IPTV-enabled device, such as the communications device 110, via the set-top box 111, the remote devices (e.g., the subscriber computer 125, etc.) or any other suitable devices. As such, to coordinate IPTV communication, the system 100 may further include the IPTV gateway 145 that is in communication with the IPTV infrastructure 140. The IPTV infrastructure 140 and the IPTV gateway 145 are used in conjunction to communicate via a network 135. For example, a suitable device (e.g., the communications device 110) at the subscriber location 105 may direct the IPTV infrastructure 140 and the IPTV gateway 145 to communicate with the content services provider system 160.

The network 135 may be an IP-based network for communication between the content services provider system 160 and the subscriber location 105 using communication devices such as but not limited to the communications device 110 (via the set-top box 111, for example). The network 135 may be implemented to transmit content from the content services provider system 160 to the subscriber location 105 via a broadband connection, for example. In exemplary embodiments, the network 135 may be a managed IP network administered by a service provider. The network 135 may also be implemented in a wireless fashion, e.g., using wireless protocols and technologies, such as Wi-Fi, Wi-Max, etc. The network 135 may also be a cellular communications network, a fixed wireless network, a wireless local area network (LAN), a wireless wide area network (WAN), a personal area network (PAN), intranet, metropolitan area network, Internet network, the Internet, or other similar types of network environments or other suitable network systems. The network 135 includes equipment for receiving and transmitting signals. In other exemplary embodiments, the network 135 may be a circuit-switched network such as a standard public switched telephone network (PSTN), a packet-switched network, or any combination thereof.

In exemplary embodiments, the IPTV infrastructure 140 may be an IP-based network that receives network data (e.g., music, audio, audio-books, audio podcasts, recorded news, etc) from the content services provider system 160, and delivers the network data to the set-top box 111 for receipt or rendering on the communications device 110. Further, pointers to the network data may be stored in the audio repository 150 for future rendering on the communications device 110. For example, a playlist of audio content containing pointers associated to audio content from the content services provider system 160 may be stored as audio data in the audio repository 150. Alternatively, the network data may be for receipt or rendering on the subscriber computer 125 or other suitable device. Further, the subscriber computer 125 or other suitable device may access the network data through pointers stored in the audio repository 150, or direct the network data to be stored in a listing format (e.g., playlist) in the audio repository 150. It is noted that a plurality of play lists and/or listings may be stored in the audio repository 150. Further, the plurality of listings may be stored in any of a plurality of folders. Moreover, the plurality of folders may be shareable/accessible by a plurality of users or subscriber locations.

In exemplary embodiments, as discussed above, the IPTV infrastructure 140 provides an interface between the subscriber location 105 and the IPTV gateway 145. In exemplary implementations, a terminal server 141, an application server 142, a media server 143, and a media content server 144 operate to interface communication between the subscriber location 105 via the set-top box 111, and the IPTV gateway 145. For example, in exemplary implementations, the set-top box 111 may provide a unique identification number such that the IPTV gateway 145 may route network data to the set-top box 111 and the audio repository 150. The network data may include audio or audio information, and may be routed to the set-top box 111 according to the operations of the IPTV infrastructure described below.

According to exemplary embodiments, the media content server 144 may operate to communicate with the audio repository 150. For example, the media content server 144 may search for music/audio listings (e.g., playlists) in the audio repository 150. The media content server 144 may search for new playlists or simply search for all available playlists in the audio repository 150. The listings may be transmitted to the media content server 144 (e.g., over the IPTV gateway 145). The media content server 144 may ingest the listings (e.g., playlists) and interpret pointers contained in the listings for associated music/audio content. The media content server 144 may make the listings available to the application server 142 and the media server 143. Alternatively, the audio repository 150 may make the listings accessible to the IPTV infrastructure 140 without intervention by the media content server 144. If a subscriber selects content for playback from the content listing (e.g., listings, playlists, etc), the media content server 144 may transcode the selected content into a format suitable for playback/access on the IPTV infrastructure 140. Further, the actual transcoded content may be transferred to the media server 143 for access/playback on the IPTV infrastructure 140. For example, the selected content from the listing(s) may be input to interpret associated content (i.e., which music/audio files are pointed to), and the selected content may be accessed through the IPTV infrastructure 140. As the selected content is interpreted and accessible by the IPTV infrastructure, the media server 143 may thus provide the content in a format decipherable by communications devices, to communications devices in communication with the IPTV system 100 (i.e., the communications device 110, set-top box 111, subscriber computer 125, etc).

It is noted that the music/audio information (e.g., listings) may be stored in any format in the audio repository 150. It is further noted that according to at least one example embodiment, the music/audio information may be stored in a listing format containing pointers associated with music/audio files available to the IPTV network. Further, the music/audio files may be transcoded from any format (e.g., a MPEG format or other format) on the content services provider system 160 (or any server available to the IPTV network) to WINDOWS MEDIA AUDIO (WMA) format. WMA format is an audio data compression technology developed by MICROSOFT, and WMA may be used to refer to a MICROSOFT audio file format or a MICROSOFT audio codec that forms part of the WINDOWS MEDIA framework and may include audio information. Moreover, the audio files may be transcoded from any format (e.g., a MPEG format or other format) on the content services provider system 160 (or any server available to the IPTV network) to WINDOWS MEDIA VIDEO (WMV) format. WMV format is an audio/video data compression technology developed by MICROSOFT, and WMV may be used to refer to a MICROSOFT video file format or a MICROSOFT video codec that forms part of the WINDOWS MEDIA framework and may include audio information.

According to exemplary embodiments, the media server 143 may receive transcoded audio information or content from the media content server 144. The transcoded content may be in a format suitable for playback on a communications device with access to the IPTV infrastructure 140 (e.g., the communications device 110/set-top box 111 and/or subscriber computer 125, etc). Furthermore, the application server 142 may receive a content listing from the media content server 144 or the audio repository 150. The content listing may include a listing of all music/audio available for access/playback through the IPTV infrastructure 140, or one or more listings created and stored by a subscriber. Further, the application server 142 may be operatively connected to the terminal server 141. Thus, the content listing may be available to the terminal server 141. The terminal server 141 may launch applications on a set-top box (i.e., the set-top box 111) and may display the content listing on the communications device 110 through the set-top box 111. Further, a subscriber may select music/audio from the content listing for playback on the communications device 110. Moreover, music/audio selected by the subscriber may be rendered on the set-top box 111 by the media server 143 for playback on the communications device 110. Additionally, if lyrics or transcriptions of associated music/audio are made available to the IPTV infrastructure 140, the lyrics/transcriptions may further rendered on the communications device. Thus, according to exemplary embodiments, the system 100 provides music/audio storage to the subscriber via IPTV, and similarly provides playback of stored music/audio via IPTV.

In exemplary embodiments, the IPTV gateway 145 may further interface with the various system 100 elements as described herein. For example, the IPTV gateway 145 may pass notifications and messages (e.g., email messages) regarding permissions to create and edit music/audio storage in the audio repository 150. For example, different members of the subscriber location 105 who share account services may have different access schedules. For example, one member may have a unique access schedule and another member may have a second unique access schedule with little to no overlap with the first access schedule. As such, each member may retrieve and edit those different schedules and be properly authenticated (e.g., through entry of a password or pin, or through subscriber identification) to retrieve and edit those schedules. Further, different members of the subscriber location 105 may create access lists or “buddy lists” of different subscriber locations. The access lists may contain a list of sharable music/audio content from the audio repository 150. The access list may further contain a list of subscribers with access to the music/audio content, account numbers, phone numbers, subscriber identification numbers, or other suitable identification means such that users spread across a wide area may access shared content from the audio repository 150 (e.g., through entry of a password or pin, or through subscriber identification). In this manner, users may travel to different geographical locations and retain access/playback capabilities of stored music/audio (i.e., network-based storage allows for remote access to personally preferred music/audio based on listings).

In exemplary embodiments, the IPTV gateway 145 may include a back end 147 and a front end 146. The front end 146 may be used to implement various provisioning activities such as but not limited to initial provisioning of IPTV addresses for the devices at the subscriber location 105. The back end 147 may be implemented for many of the audio storage services, such as communicating with the content services provider system 160, passing messages and notification to the IPTV gateway 145, etc. As such, the back end 147 may include various elements (e.g., 148, 149) including but not limited to a caller ID handler, Short Message Service (SMS) handler, message handler, provisioning handler, etc. It is noted, however, that more or less elements could be included depending upon any particular implementation. Therefore, exemplary embodiments should not be limited by the particular number of elements (i.e., 148, 149) illustrated.

In exemplary embodiments, the IPTV gateway 145 may implement authentication using a high-speed processing device (e.g., a computer system) that is capable of handling high volume activities conducted via communications devices, and other network entities (e.g., parts of the IPTV infrastructure 140, network 135, etc.) via one or more networks (e.g., the network 135). The IPTV gateway 145 receives requests from one or more devices from the subscriber location 105 to access network services, such as stored music/audio. The IPTV gateway 145 may implement authentication software for restricting or controlling access to network. The IPTV gateway 145 may be in communication with a customer identity system (CIS) database, which stores subscriber credentials (e.g., subscriber names and passwords) for access to IPTV services. Further, the IPTV gateway 145 may access the buddy list of a subscriber location to verify accessibility of stored music/audio.

In exemplary embodiments, as discussed above, the system 100 further includes the content services provider system 160, which is in communication with the IPTV gateway 145 via the network 135. In exemplary embodiments, the content services provider system 160 is implemented by a host system (e.g., a high-speed processing device) that provides content to its subscribers (e.g., a subscriber of communications device 110), such as television programs, premium programming services, video on demand content, and Internet/Web content (e.g., podcasts, streaming media, etc.). In exemplary embodiments, the content is transmitted to the subscribers (e.g., at subscriber location 105) via a broadband connection over an Internet Protocol (IP)-based network (e.g., the network 135). The content services provider system 160 may also provide an onscreen programming guide to subscribers that provides information about current and future programming available via the content providers' services, such as movies or music that are to be available in the future. Programming information provided by the onscreen programming guide may include current and future program listings including but not limited to program titles, program producers, begin time, duration of program, a date in which the program was produced, and a brief text description of the program.

In exemplary embodiments, the content services provider system 160 is coupled to a database 165, which may include stored music/audio. In addition, the database 165 may include one or more playlists for available music/audio (e.g., organized by album, artist, etc). In exemplary embodiments, access to the database 165 and the associated communication between the database 165 and the media content server 144 may be implemented by exemplary methods described herein.

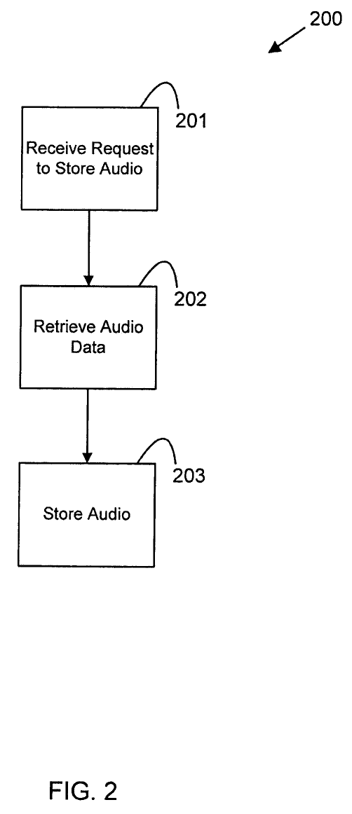

FIG. 2 illustrates a flow chart for a method of music/audio storage 200 in accordance with exemplary embodiments. As discussed above, a subscriber may interact with a communications device (e.g., the communications device 110) and select audio and other content to access. In step 201, a request to store audio may be received. The request may be received by a computing device from a subscriber issuing a selection on a communications device, for example, the set-top box 111 and communications device 110 discussed above. Furthermore, the request may be received by an IPTV infrastructure, such as the IPTV infrastructure 140, from a set-top box, such as the set-top box 111 or remote station, such as the computer 125. The request to store audio may be a request to store audio available to the IPTV infrastructure 140. The audio may be stored as audio data in any format including but not limited to a listing containing pointers to individually associated audio files, and may be stored in an audio repository (i.e., the audio repository 150).

Further illustrated in FIG. 2, upon receipt of a request to store audio, step 202 includes retrieving audio data to store. For example, the IPTV infrastructure 140 may retrieve the audio data from a content services provider system, such as the system 160 (i.e., audio data including location or access information for audio files). The audio data may be retrieved from the content services provider system (e.g., the content services provider system 160) and made accessible to the audio repository 150. For example, as set forth in step 203, the audio is stored in the audio repository 150.

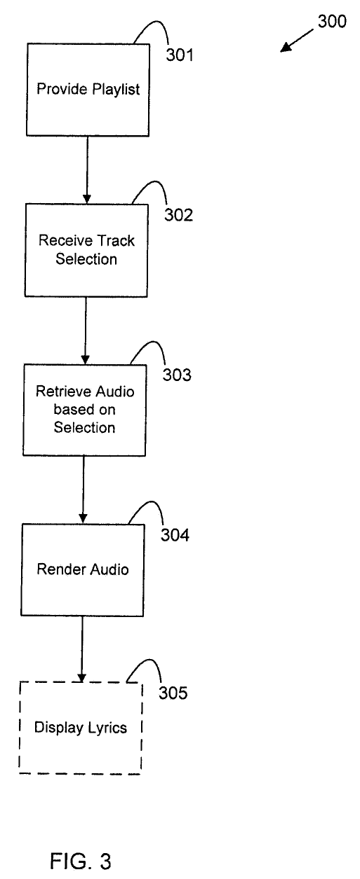

Additionally, the stored audio may be accessed by a communications device, such as the communications device 110. For example, audio may be streamed to a set-top box, such as the set-top box 111, as streaming audio from a media server, such as the media server 143. Upon receipt of the streaming audio, the set-top box 111 may render the audio on the communications device 110. Alternatively, the audio may be rendered on a remote computer (e.g., the subscriber computer 125) or other communications device. Hereinafter, a method of music/audio storage 300 is described with reference to FIG. 3.

Turning to FIG. 3, the method 300 may include providing a playlist at step 301. For example, a set-top box, such as the set-top box 111, may provide a playlist to be displayed at the communications device. The user may navigate an interface displayed on a communications device (e.g., the communications device 110), select a portion or portions of the playlist, and request the selected portion(s) be rendered on the communications device. Accordingly, the method 300 may further include receiving track selection(s) and retrieving audio data to be rendered at steps 302 and 303. The audio data may be stored in an audio repository (e.g., the audio repository 150), and may be accessed by a media content server (e.g., the media content server 144). The media content server 144 may ingest the audio data, locate associated content through an IPTV network, and transcode the associated content into a format suitable for playback on the communications device. The transcoded content may be transferred to a media server (e.g., the media server 143), and may be rendered on the communications device 110 (see step 304). For example, the media server 143 may stream the audio as streaming audio to the communications device 110.

The method 300 may further include displaying lyrics at step 305. For example, audio files accessible by the IPTV network may have associated lyrics and/or transcriptions available. Thus, upon rendering the audio, or at substantially the same time as rendering the audio, the lyrics/transcriptions may also be rendered. It is noted that rendering lyrics/transcriptions is optional, and may be provided as a selectable option for subscribers of the IPTV network. Similarly, associated artwork (e.g., posters, album covers, network logos, etc) may also be rendered at a communications device according to exemplary embodiments.

Therefore, as described above, exemplary embodiments include methods of storing music/audio via IPTV. An exemplary method may include receiving a request to store audio data, retrieving the audio data through an Internet Protocol television (IPTV) network, and storing the audio data in an audio repository in communication with the IPTV network. Further, exemplary methods may include providing a playlist(s), receiving a track selection, retrieving audio based on the selection, and rendering audio. Exemplary embodiments may further include rendering lyrics/transcriptions of audio and/or rendering artwork associated with audio content. It is noted that although exemplary embodiments of the present invention have been shown and described with regard to certain operations (e.g., method steps 201-203 of FIG. 2 and method steps 301-305 of FIG. 3) being performed serially or consecutively, it will be understood that any combination of these operations may be performed simultaneously and in parallel.

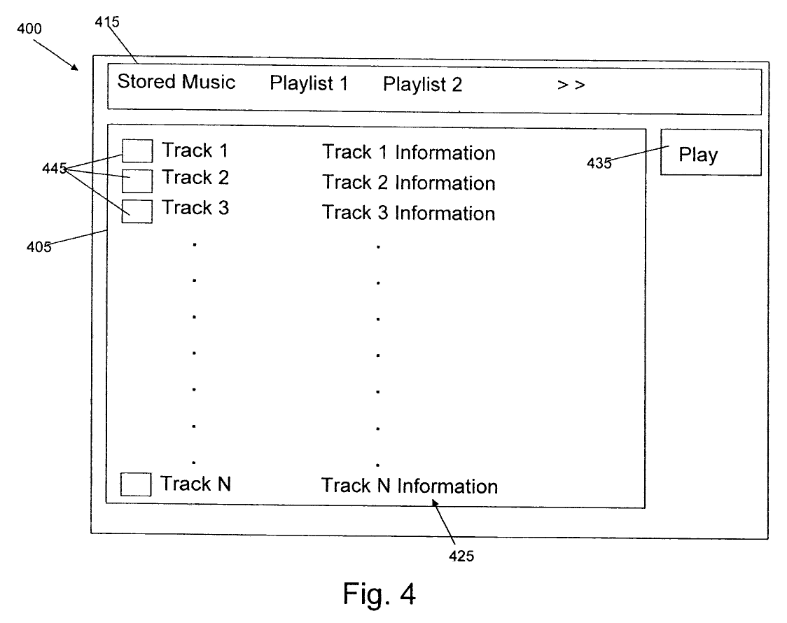

It is further noted that the methods above may be implemented by an audio storage system similar to, or substantially similar to, the system 100 of FIG. 1. However, exemplary embodiments should not be limited to only systems implemented with the particular components and/or connections depicted therein. For example, various components and/or connections may be included or not included for implementation of methods according to exemplary embodiments. Hereinafter, a music/audio storage system interface is described with reference to FIG. 4.

FIG. 4 illustrates a screen shot of an exemplary music/audio storage system interface 400, which may be accessed and displayed on a communications device (e.g., the communications device 110), or any other subscriber devices at the subscriber location 105. As described above, the subscriber may select music/audio from a listing provided by the application launched by the IPTV infrastructure 140 (e.g., the terminal server 141 of the IPTV infrastructure 140 using a portion 445 of a listing field 405). In exemplary embodiments, the listing may be stored locally on the set-top box 111 or on the IPTV infrastructure 140, and be locally accessed to populate the listings field 405 on the interface 400. The listing may be periodically updated by an application server of the IPTV infrastructure 140 (e.g., the application server 142). In exemplary embodiments, the subscriber may search through the listing via a search field (not illustrated) or through scrolling manually through the listing. It is appreciated that there are various search methods known in the art that may be implemented for the search field. Furthermore, it is appreciated that scroll buttons may be included in the interface 400, or on a remote control, such as the remote control 115, of the set-top box 111. The user may use a select key on the remote control 115 or a play button on the remote control to request rendering of the selected music/audio. Further, the user may use a play selection portion 435 of the interface 400 to request rendering as well.

It is appreciated that the subscriber may navigate the interface 400 with the remote control 115 if the interface is displayed on the communications device 111. Alternatively, the subscriber may navigate the interface 400 using a remote communications device such as a PDA, cell phone, etc. The subscriber may navigate through alternate listings of content using a display portion 415 (i.e., different categories of music/audio, different playlists, etc), or through a complete listings of all content available such as through an on-screen programming guide. Furthermore, the interface 400 may include a music/audio information portion 425 in the listing field 405 which includes information relating to individual music/audio files. It is appreciated that the music/audio information portion 425 may display relevant information of all audio simultaneously, or may display information of a presently selected track. Furthermore, the information displayed for a music/audio file may include information from meta-data stored within the digital media file containing the audio or information provided by a content services provider system. The information may include date of release, artist or author, content, etc.

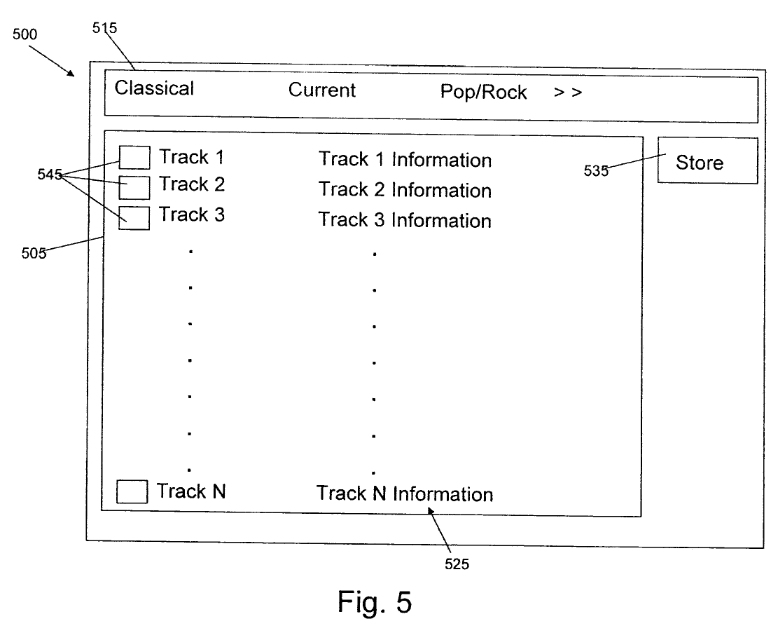

The interface 400 may be rendered on a communications device (e.g., the communications device 110) of the IPTV infrastructure 140. Alternatively, the interface 400 may be included on a web-page remotely accessible using a remote communications device as noted above. The web-page may be provided by a server within the IPTV infrastructure 140, or a remote server used for web-serving to remote communications devices. The remote communications devices may be associated with the subscriber's account and/or location as discussed with reference to FIG. 1 above. Hereinafter, a music/audio storage system interface 500 is described with reference to FIG. 5.

Turning to FIG. 5, an exemplary embodiment of the music/audio storage system interface 500, which may be accessed and displayed on a communications device (e.g., the communications device 110), or any of the other subscriber devices at the subscriber location 105 is illustrated. As described above, the subscriber may select music/audio from a listing provided by the application launched by the IPTV infrastructure 140 (e.g., the terminal server 141 of the IPTV infrastructure 140). In exemplary embodiments, the listing may be stored locally on the set-top box 111 or on the IPTV infrastructure 140, and be locally accessed to populate a listings field 505 on the interface 500. The listing may be periodically updated by an application server of the IPTV infrastructure 140 (e.g., the application server 142). In exemplary embodiments, the subscriber may search through the listing via a search field (not illustrated) or through scrolling manually through the listing. It is appreciated that there are various search methods known in the art that may be implemented for the search field. Furthermore, it is appreciated that scroll buttons may be included in the interface 500, or on the remote control 115 of the set-top box 111. The user may use a select key on the remote control 115 or a record button on the remote control to request storage of audio data. Alternatively, the user may use a store request portion 535 of the interface to request storage of audio data.

According to at least one exemplary embodiment, all currently selected tracks (i.e., an individual audio/music files selected using portion 545) may be stored as a listing in an audio repository, such as the audio repository 150, upon a request to store. Alternatively, a user may highlight one or more tracks (i.e., individual audio/music files) using a remote or input device, and may store highlighted tracks in a listing in the audio repository. Further, any combination of the above described implementations may also be used according to some exemplary embodiments.

It is appreciated that the subscriber may navigate the interface 500 with the remote control 115 if the interface is displayed on the communications device 110. Alternatively, the subscriber may navigate the interface 500 using a remote communications device such as a PDA, cell phone, etc. The subscriber may navigate through alternate listings of a stored music/audio using display portion 515 (i.e., different categories of music/audio, different playlists, etc), or through a complete listings of all music/audio available to the subscriber. Furthermore, the interface 500 may include a music/audio information portion 525 in the listing field 505 which includes information relating to individual music/audio files. It is appreciated that the music/audio information portion 525 may display relevant information of all tracks simultaneously, or may display information of a presently selected track. Furthermore, the information displayed for a track may include information from meta-data stored within the digital media file containing the track or information provided by a content services provider system, such as the system 160. The information may include date of release, artist or author, content, date of storage or recording, user whom requested recording, location, etc.

The interface 500 may be rendered on a communications device (e.g., the communications device 110) of the IPTV infrastructure 140. Alternatively, the interface 500 may be included on a web-page remotely accessible using a remote communications device as noted above. The web-page may be provided by a server within the IPTV infrastructure 140, or a remote server used for web-serving to remote communications devices. The remote communications devices may be associated with the subscriber's account and/or location as discussed with reference to FIG. 1 above.

As described herein, exemplary embodiments of the present invention may be implemented, in software, for example, as any suitable computer program. For example, a program in accordance with one or more exemplary embodiments of the present invention may be a computer program product causing a computer to execute one or more of the example methods described herein directly on a host processor.

The computer program product may include a computer-readable medium having computer program logic or code portions embodied thereon for enabling a processor of the apparatus to perform one or more functions in accordance with one or more of the example methodologies described above. The computer program logic may thus cause the processor to perform one or more of the example methodologies, or one or more functions of a given methodology described herein.

The computer-readable storage medium may be a built-in medium installed inside a computer main body or removable medium arranged so that it can be separated from the computer main body. Examples of the built-in medium include, but are not limited to, rewriteable non-volatile memories, such as RAMs, ROMs, flash memories, and hard disks. Examples of a removable medium may include, but are not limited to, optical storage media such as CD-ROMs and DVDs; magneto-optical storage media such as MOs; magnetism storage media such as floppy disks (trademark), cassette tapes, and removable hard disks; media with a built-in rewriteable non-volatile memory such as memory cards; and media with a built-in ROM, such as ROM cassettes.

These programs may also be provided in the form of an externally supplied propagated signal and/or a computer data signal (e.g., wireless or terrestrial) embodied in a carrier wave. The computer data signal embodying one or more instructions or functions of an example methodology may be carried on a carrier wave for transmission and/or reception by an entity that executes the instructions or functions of the example methodology. For example, the functions or instructions of the example embodiments may be implemented by processing one or more code segments of the carrier wave, for example, in a computer, where instructions or functions may be executed directly on a host processor, in accordance with exemplary embodiments of the present invention. The carrier wave may be propagated over copper wire waveguides (e.g., coax or other cabling), optical waveguides (e.g., optical fiber), and may be implemented using any available protocol for carrier wave propagation. For example, in fiber-optic implementations, a fiber to the node (FTTN) or fiber to the premises (FTTP) implementation may be suitable. For example, in copper wire implementations, the carrier wave may be propagated through a digital cable infrastructure. Additionally, combinations of these examples may be used, such as a hybrid approach or Hybrid fibre-coaxial (HFC) implementations.

Further, such programs, when recorded on computer-readable storage media, may be readily stored and distributed. The storage medium, as it is read by a computer, may enable the methodologies described herein directly on a host processor, in accordance with the exemplary embodiments of the present invention.

Exemplary embodiments of the present invention being thus described, it will be obvious that the same may be varied in many ways. For example, the methods according to example embodiments of the present invention may be implemented in hardware and/or software. The hardware/software implementations may include a combination of processor(s) and article(s) of manufacture. The article(s) of manufacture may further include storage media and executable computer program(s), for example, a computer program product stored on a computer readable medium.

The executable computer program(s) may include the instructions to perform the described operations or functions. The computer executable program(s) may also be provided as part of externally supplied propagated signal(s). Such variations are not to be regarded as departure from the spirit and scope of the exemplary embodiments of the present invention, and all such modifications as would be obvious to one skilled in the art are intended to be included within the scope of the following claims.

What is claimed is:

1. A network-based method for providing audio storage, the method comprising:
receiving a request to store audio data;
retrieving the audio data through an Internet Protocol television (IPTV) network; and
storing the audio data in an audio repository in communication with the IPTV network.

2. The method of claim 1, further comprising:
providing an audio file listing of audio files available to the IPTV network; and
receiving an audio file selection from the listing, wherein retrieving the audio data is based on the audio file selection.

3. The method of claim 2, further comprising:
initiating an encoding session to translate audio files included in the audio file selection; and
rendering the translated audio files on a communications device.

4. The method of claim 3, wherein the audio files are encoded to a WINDOWS MEDIA format for rendering on the communications device.

5. The method of claim 2, wherein the audio data is stored in a listing format containing pointers associated with the audio files available to the IPTV network.

6. The method of claim 2, further comprising rendering lyrics associated with the audio file selection on a communications device.

7. The method of claim 6, wherein the communications device is an Internet Protocol-enabled television.

8. The method of claim 2, further comprising providing a transcoded format of audio files included in the audio file selection to a communications device address of a communications device.

9. The method of claim 8 wherein the communications device address includes at least one of a uniform resource locator and an Internet address.

10. The method of claim 8, wherein the communications device includes a set-top box.

11. The method of claim 1, wherein the audio repository is accessible by devices authenticated on the IPTV network.

12. A system for providing network-based audio storage, the system comprising:
a computer processing device; and
an audio storage application executing on the computer processing device, the audio storage application including:
receiving a request to store audio data,
retrieving the audio data through an Internet Protocol television (IPTV) network, and
storing the audio data in an audio repository in communication with the IPTV network.

13. The system of claim 12, wherein the audio storage application further includes:
providing an audio file listing of audio files available to the IPTV network; and
receiving an audio file selection from the listing, wherein retrieving the audio data is based on the audio file selection.

14. The system of claim 13, wherein the audio storage application further includes:
initiating an encoding session to translate audio files included in the audio file selection; and
rendering the translated audio files on a communications device.

15. A computer program product for network-based audio storage, the computer program product including instructions for causing a computer to implement a method, the method comprising:
receiving a request to store audio data;
retrieving the audio data through an Internet Protocol television (IPTV) network; and
storing the audio data in an audio repository in communication with the IPTV network.

16. The computer program product of claim 15, wherein the method further includes:
providing an audio file listing of audio files available to the IPTV network; and
receiving an audio file selection from the listing, wherein retrieving the audio data is based on the audio file selection.

17. The computer program product of claim 16, wherein the method further includes:
initiating an encoding session to translate audio files included in the audio file selection; and
rendering the translated audio files on a communications device.

18. The computer program product of claim 17, the audio files are encoded to a WINDOWS MEDIA format for rendering on the communications device.

19. The computer program product of claim 16, wherein the audio data is stored in a listing format containing pointers associated with the audio files available to the IPTV network.

20. The computer program product of claim 16, further comprising rendering lyrics associated with the audio file selection on an Internet Protocol-enabled television.
